(19) United States
(12) Patent Application Publication
(10) Pub. No.: US 2026/0187617 A1
(43) Pub. Date: Jul. 2, 2026

(54) INTERACTION COUNTERS FOR MULTI-DEVICE TRANSACTIONS

(71) Applicants: American Express Travel Related Services Company, Inc., New York, NY (US); American Express Services Europe Limited, London (GB)

(72) Inventors: Alaric M. Eby, Scottsdale, AZ (US); Manik Biswas, Burgess Hill (GB); Mukund Shankar SimhaRaghu, Glendale, AZ (US)

(21) Appl. No.: 19/003,106

(22) Filed: Dec. 27, 2024

(51) Int. Cl. G06Q 20/32; G06Q 20/22

(52) U.S. Cl. CPC G06Q 20/3278; G06Q 20/22

(57) ABSTRACT

Disclosed are various embodiments for implementing a interaction counter to enable multi-device transactions. A computing device can receive an input from a user interface, the input indicating a number of interactions associated with a transaction session. The computing device can generate an interaction counter for the transaction session based at least in part on the number of interactions. Next, the computing device can send a request for a first set of data corresponding to a first interaction and receive the first set of data in response to the request. Then the computing device can increment the interaction counter based at least in part on the first data for the first interaction.

### BACKGROUND

Contactless transactions are stateless, meaning that prior interactions are not considered in subsequent interactions. Because of this, multi-party or multi-part interactions must be completed separately, either before a contactless transaction or after the transaction. For example, to split a charge with a friend, one person must complete the transaction, and the other must contribute before or after the transaction is complete.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1 and 2A-2B are pictorial diagrams of an example of interactions between a client device and a transaction terminal according to various embodiments of the present disclosure.

FIG. 3 is a drawing of a network environment according to various embodiments of the present disclosure.

FIG. 4 is a flowchart illustrating one example of functionality implemented as portions of an application executed in a computing environment in the network environment of FIG. 3 according to various embodiments of the present disclosure.

FIG. 5 is a flowchart illustrating one example of functionality implemented as portions of an application executed in a computing environment in the network environment of FIG. 3 according to various embodiments of the present disclosure.

FIG. 6 is a sequence diagram illustrating one example of interactions between components in the network environment of FIG. 3 according to various embodiments of the present disclosure.

FIG. 7 is a sequence diagram illustrating one example of interactions between components in the network environment of FIG. 3 according to various embodiments of the present disclosure.

### DETAILED DESCRIPTION

Disclosed are various approaches for implementing a interaction counter to enable multi-device transactions. Because contactless interactions are stateless, contactless interaction terminals do not maintain any history of interactions/connections between sessions, nor do they allow back-to-back connections from the same device or multiple devices within the same session. After every interaction, the session between the secure element of the device and the terminal will reset, thus requiring the connection to be established again. Thus, when trying to complete a multi-interaction transaction (e.g., splitting a payment amongst two or more transaction cards, providing identity proof and payment information, etc.), a terminal will need to open multiple transaction sessions in order to complete the full transaction. Requiring the establishment of a new session for each portion of a multi-part transaction consumes both time and computing resources on both the client device and the transaction terminal.

Further, once a session has closed, the data collected by the secure element would be handed over to another application to manage the backend server interaction. As the data or information travels between the secure element and the backend application, it may be prone to security attacks. Thus, when multiple sessions are necessary, the secure element lacks sufficient control to validate information before passing it to the backend application.

Accordingly, the present invention provides for the generation and inclusion of a interaction counter which can be sent as a unique flag to the transaction terminal. The transaction terminal can receive the flag and determine the number of interactions to expect before the transaction is complete. By including a interaction counter, the terminal can keep a transaction session open until the requisite number of interactions have been completed. Then, the terminal can close the transaction session and proceed with processing. Thus, by including the interaction counter, the time and computing resources needed to complete a multi-interaction transaction is greatly reduced. Similarly, security of the interactions is increased by reducing the overall number of vulnerable transfers between a terminal application and a backend application.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

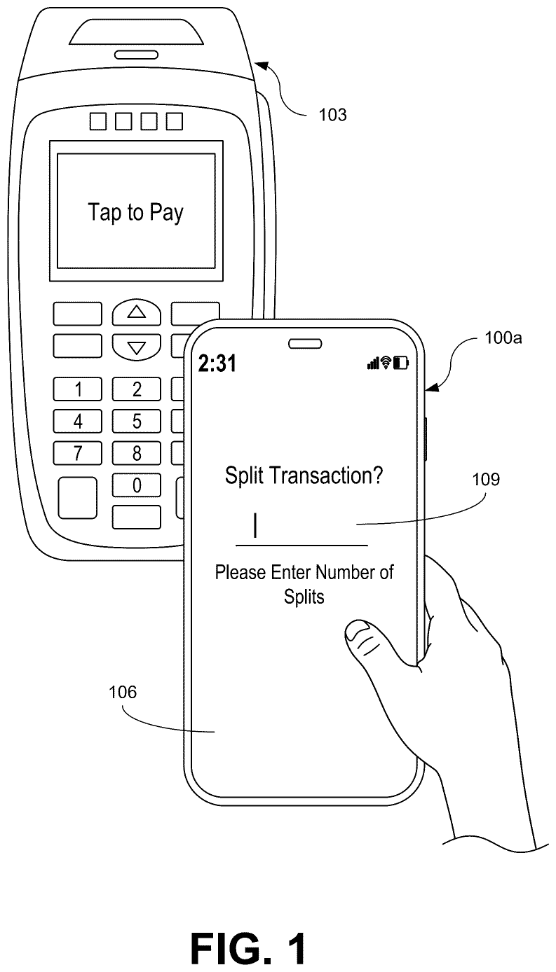

As illustrated in FIG. 1, a client device 100a can interact with a transaction terminal 103 to complete a transaction. While FIG. 1 depicts a client device 100a as a mobile phone, it is understood that interactions and transactions referred to herein are also capable of including other instruments such as the use of a payment instrument, identity card, or other device enabled to share data in a contactless interaction. When a user is at a merchant or vendor's physical location, the user can present their client device 100a to complete an interaction with a transaction terminal 103. In some examples, the client device 100a and the transaction terminal 103 can communicate via a short-range wireless connection in order to complete various tasks. The short-range wireless connection can be a near-field communication (NFC) connection, a BLUETOOTH® connection, an ultrawideband connection, a WiFi connection, or other form of short-range wireless connection.

Once a connection has been established between the client device 100 and the transaction terminal 103, the transaction terminal 103 can request data from the client device 100a to complete a transaction. The client device 100a can communicate the requested information to the transaction terminal 103 over the connection. In some examples, the communication can comprise an exchange of encrypted data such as transaction information, payment information, identity information, or other information. In some examples, a transaction may need to be split between multiple devices to be complete.

In the example user interface 106 of the client device 100a, the user is presented with an option to split a transaction. In some instances, a user may wish to split a transaction between two or more devices. For example, a user could split a payment between two or more different digital wallets, payment cards, or other devices capable of completing a transaction. The user interface 106 of FIG. 1 includes a user interface element 109 with which the user can interact. The user interface element 109 can comprise a field for entering a number or value, a button, a toggle, a slide, or another form of user interface element 109. In FIG. 1, the user can choose a number of splits for the transaction or a number of interactions which will occur.

However, in some examples, a user can select an amount to pay towards a transaction instead of the number of splits. The client device 100a can send the authorized amount with payment information to the terminal 103. The terminal 103 could then allow further payment instruments to be used to pay towards the balance of the transaction. In such embodiments, the terminal 103 can determine that a total balance for a transaction has not been met by the first interaction and keep a transaction session open for further interactions until the total balance has been satisfied.

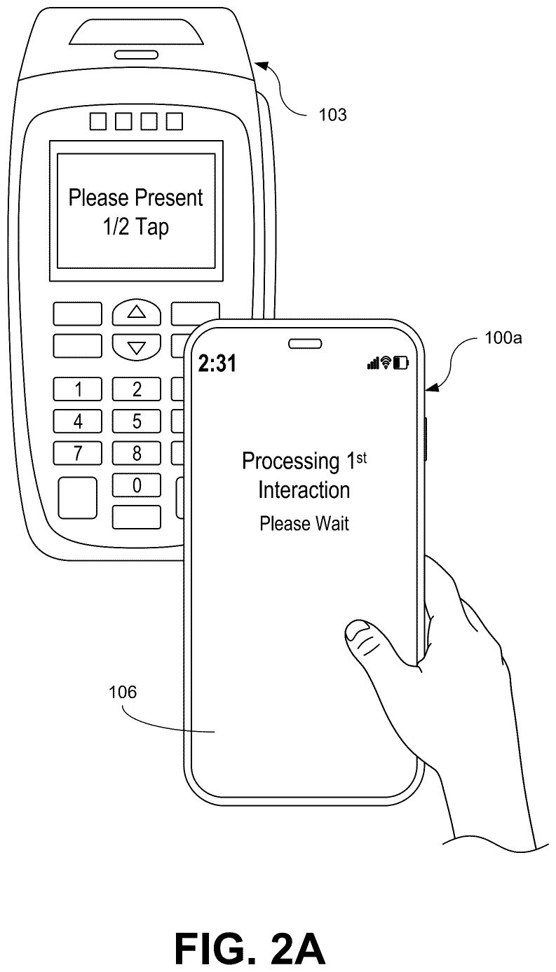

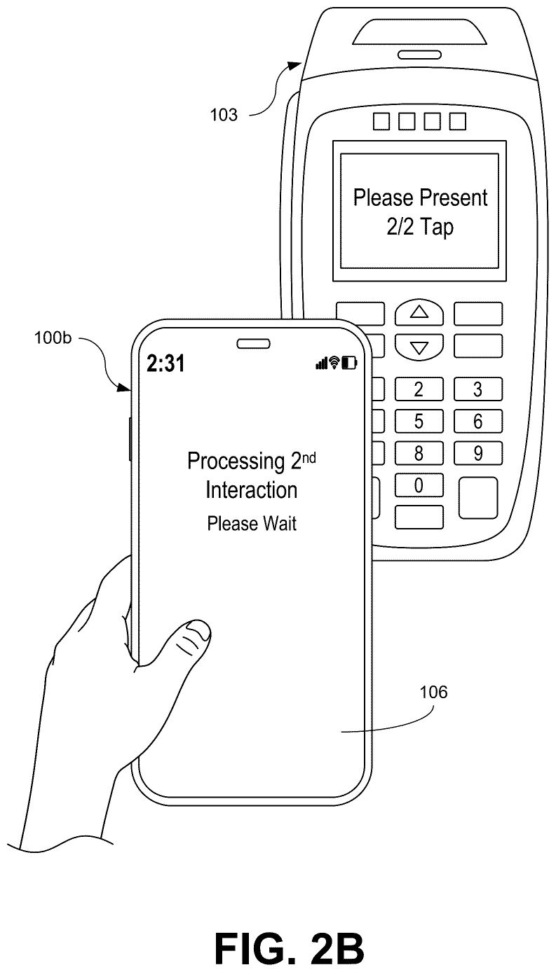

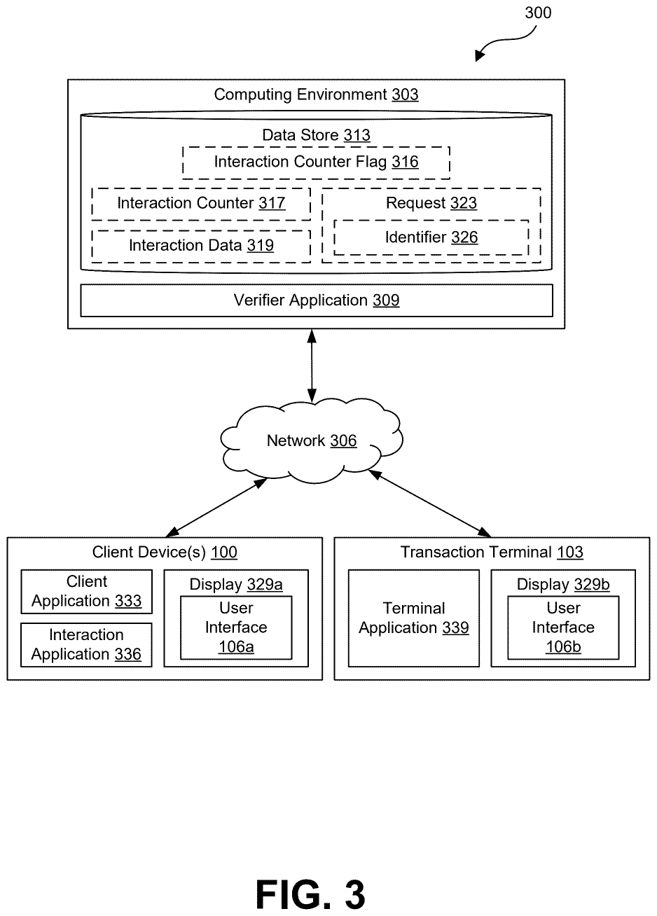

In FIG. 2A, shown is a second example of an interaction between the client device 100a and the transaction terminal 103. The client device 100a can display a second user interface 106 when the first step of the transaction occurs. After a number of splits has been established, an interaction counter 317 (see FIG. 3) can be generated based at least in part on the number of splits. The interaction counter 317 can be sent to the transaction terminal 103. In some examples, the client device 100a can send data in a first interaction. As shown in FIG. 2A, the first interaction can comprise a ‘tap’ or contactless interaction such as a near-field communication (NFC) or other short-range wireless interaction. The client device 100a and the transaction terminal 103 can share data to complete the first interaction of the transaction. The transaction terminal 103 can increment the interaction counter 317 in response to this interaction.

Moving to FIG. 2B, shown is an example of an interaction between a second client device 100b and a transaction terminal 103. In some examples, a second interaction can be completed with a second client device 100b. However, in some examples, a second interaction can be accomplished with another application on the same client device 100a. In the example of FIG. 2B, a second client device 100b can complete the transaction by exchanging information with the transaction terminal 103 in another contactless interaction. The transaction terminal 103 can increment the interaction counter 317 in response to this interaction. In some examples, the transaction terminal 103 can determine that all interactions have been completed and close the transaction session.

With reference to FIG. 3, shown is a network environment 300 according to various embodiments. The network environment 300 can include a computing environment 303, one or more client devices 100, and a transaction terminal 103, which can be in data communication with each other via a network 306.

The network 306 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 306 can also include a combination of two or more networks 306. Examples of networks 306 can include the Internet, intranets, extranets, virtual private networks (VPNs), and similar networks.

The computing environment 303 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 303 can employ a plurality of computing devices that can be arranged in one or more server banks or computer banks or other arrangements. Such computing devices can be located in a single installation or can be distributed among many different geographical locations. For example, the computing environment 303 can include a plurality of computing devices that together can include a hosted computing resource, a grid computing resource or any other distributed computing arrangement. In some cases, the computing environment 303 can correspond to an elastic computing resource where the allotted capacity of processing, network, storage, or other computing-related resources can vary over time.

Various applications or other functionality can be executed in the computing environment 303. The components executed on the computing environment 303 include a verifier application 309, and other applications, services, processes, systems, engines, or functionality not discussed in detail herein.

The verifier application 309 can be executed to verify interaction data 319. After a merchant or vendor has received the interaction data 319 at the transaction terminal 103, the merchant/vendor can forward the interaction data 319 to the verifier application 309 to extract information, verify the data, process the data, and complete the transaction. In some examples, the verifier application 309 can be part of a financial institution associated with a payment instrument client device 100. In some examples, the verifier application 309 can be associated with the issuer of an identity instrument client device 100.

Also, various data is stored in a data store 313 that is accessible to the computing environment 303. The data store 313 can be representative of a plurality of data stores 313, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 313 is associated with the operation of the various applications or functional entities described below. This data can include interaction counter tags 316, interaction counters 317, interaction data 319, requests 323, identifiers 326, and potentially other data.

The interaction counter flag 316 represents an indication to a transaction terminal 103 to implement an interaction counter protocol layer for the short-range wireless communication between devices. The interaction counter flag 316 can be represented as a single or multiple Boolean values, one or more alphanumeric values, or any combination thereof. In some examples, the interaction counter flag 316 can be sent along with interaction data 319. For example, the interaction counter flag 316 can be shared from one device to another. Upon receipt of the interaction counter flag 316, the recipient device can determine that the interaction counter flag 316 represents a protocol for the device to follow during the interaction. In some examples, the interaction counter flag 316 can represent instructions to hold open a transaction session for multiple interactions. The interaction counter flag 316 can specify the number of interactions expected and, in some examples, can specify the number of devices that will be involved. The interaction counter flag 316 can cause a recipient device to include an interaction counter 317.

An interaction counter 317 can represent a value that can be incremented for each interaction in which a client device 100 provides interaction data 319. The interaction counter 317 can track a total number of interactions as well as the current state of interactions. In some examples, the interaction counter 317 is an integer value which is incremented until a total is reached. In some examples, the interaction counter 317 is represented as a fraction where the numerator represents the current count for the interactions and the denominator represents a total expected number of interactions. For example, the interaction counter 317 can be represented as ½, where two interactions are expected, but only one interaction has occurred so far.

Interaction data 319 can represent data associated with an interaction which is transferred between parties to the interaction. In some examples, interaction data 319 can include a transaction time, date, amount, merchant identifier, a transaction identifier, payment information, identity information, or other information about an interaction. In some examples, interaction data 319 can be associated with an identifier 326 indicating to which request 323 the interaction data 319 corresponds.

Individual requests 323 can represent a message or prompt to send interaction data 319. A request 323 can be a request for identity verification, payment information, or other secure information. For example, a request 323 can be sent from a transaction terminal 103 to an interaction application 336 to request information to complete a transaction. In some examples, a request 323 can be encrypted as a cryptogram and sent over a secure channel to the client device 100, payment instrument, identity instrument, etc. The request 323 can include a unique identifier 326.

Individual identifiers 326 are representative of a unique sequence of numbers or characters which are specific to a request 323. Individual identifiers 326 can also include a counter for the requests 323, or otherwise indicate a relative count of the requests 323. For example, if two requests 323 are sent, each request will have a unique identifier 326 which can indicate ½, ⅔, 4/4, etc. to inform the recipient of the number of associated requests 323.

The client device 100 is representative of a plurality of client devices that can be coupled to the network 306. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay^{®}players, digital video disc (DVD) players, set-top boxes, and similar devices), a videogame console, or other devices with like capability. In some examples, the client device 100 can represent a Europay, MasterCard, Visa (EMV) payment instrument having a chip with a processor, memory, and various ‘applet’ applications. In some examples, the client device 100 can represent other EMV-enabled instruments such as identification cards or badges, etc. The client device 100 can include one or more displays 329a, such as liquid crystal displays (LCDs), gas plasma-based flat panel displays, organic light emitting diode (OLED) displays, electrophoretic ink (“E-ink”) displays, projectors, or other types of display devices. In some instances, the display 329a can be a component of the client device 100 or can be connected to the client device 100 through a wired or wireless connection.

The client device 100 can be configured to execute various applications such as a client application 333 or other applications. The client application 333 can be executed in a client device 100 to access network content served up by the computing environment 303 or other servers, thereby rendering a user interface 106 on the display 329a. To this end, the client application 333 can include a browser, a dedicated application, or other executable, and the user interface 106 can include a network page, an application screen, or other user mechanism for obtaining user input. The client device 100 can be configured to execute applications beyond the client application 333 such as email applications, social networking applications, word processors, spreadsheets, an interaction application 336, or other applications.

The interaction application 336 can be executed to manage interactions between a client device 100 and a transaction terminal 103. The interaction application 336, hosted on the client device 100, can establish a short-range wireless connection with a terminal application 339. Using this connection, the interaction application 336 can receive inputs such as user inputs from a user interface 106, and/or requests 323 for data from a terminal application 339. The interaction application 336 can generate an interaction counter flag 316 based at least in part on inputs and/or requests 323 and send the interaction counter flag 316 to the transaction terminal 103. In some examples, the interaction application 336 can send various interaction data 319 in response to receipt of the requests 323.

The transaction terminal 103 is representative of a plurality of payment terminals that can be coupled to the network 306. The transaction terminal 103 can include a processor-based system such as a computer system. Such a computer system can be embodied in the form of a designated point-of-sale (POS) machine, a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. The transaction terminal 103 can include one or more displays 329b, such as liquid crystal displays (LCDs), gas plasma-based flat panel displays, organic light emitting diode (OLED) displays, electrophoretic ink (“E-ink”) displays, projectors, or other types of display devices. In some instances, the display 329b can be a component of the transaction terminal 103 or can be connected to the transaction terminal 103 through a wired or wireless connection.

The transaction terminal 103 can be configured to execute various applications such as a terminal application 339 or other applications. The terminal application 339 can be executed in the transaction terminal 103 to access network content served up by the computing environment 303 or other servers, thereby rendering a user interface 106b on the display 329b. The terminal application 339 can be executed to establish a connection with the interaction application 336 or the verifier application 309, to set up an interaction counter 317, and to exchange interaction data 319, requests 323, and other information.

Next, a general description of the operation of the various components of the network environment 200 is provided. Although the following description provides one illustrative example of the operations of and interactions between the various components of the network environment 200, other operations and interactions are also encompassed by the various embodiments of the present disclosure. More detailed discussion of the operations of individual components is provided in the discussion accompanying the subsequent drawings.

To begin, a user and a vendor can agree to a transaction. To participate in the transaction, a client device 100 can be presented to a transaction terminal 103 to complete a contactless transaction. An interaction application 336 on the client device 100 can be activated and establish a connection with the terminal application 339. After the connection has been established, the terminal application 339 can send one or more requests 323 for data to the interaction application 336. The interaction application 336 can generate and present a split message in a user interface 106 on the client device 100. The split message can comprise an option for a user to enter a number of interactions which will occur to complete the transaction. In some examples, the terminal application 339 presents a split message on a user interface 106 of the transaction terminal 103 instead. Then, the user of the transaction terminal 103 can enter a number of interactions necessary to complete the transaction. Once an input has been received in response to the split message, whether by the interaction application 336 or the terminal application 339, an interaction counter flag 316 can be generated based at least in part on the input. When the interaction application 336 receives the input, the interaction application 336 generates the interaction counter flag 316. Similarly, if the terminal application 339 received the input, the terminal application 339 can generate the interaction counter flag 316. The interaction counter flag 316 can then be sent to or stored on the transaction terminal 103.

Once the transaction terminal 103 has the interaction counter flag 316, the transaction can proceed. The transaction terminal 103 can implement an interaction counter 317 in response to receiving the interaction counter flag 316. In some examples, a first client device 100a will use an interaction application 336a to send first data in response to a request 323. Once the terminal application 339 receives the first data, the terminal application 339 increments the interaction counter 317. Various other client devices 100 can be involved in the transaction, depending at least in part on the interaction counter flag 316 and the specified number of interactions from the input. In some examples, multiple interaction applications 336 on the same client device 100 can participate in the transaction. In some examples, multiple client devices 100 belonging to the same user can participate. For example, a user could present a payment instrument and an identification card to complete a transaction. However, in some examples, multiple client devices 100 of multiple users can participate in the transaction. For example, a first user could present their payment instrument, and a second user could present their payment instrument.

Each time a client device 100 or interaction application 336 sends interaction data 319 to the terminal application 339, the terminal application 339 can increment the interaction counter 317. The terminal application 339 can further determine when the interaction counter 317 has reached the total expected number of interactions. In some examples, the terminal application 339 waits until the total number of interactions has been completed before sending the various interaction data 319 to a verifier application 309. In some examples, the terminal application 339 sends each portion of interaction data 319 received to a respective verifier application 309 as soon as it is received. Once the total number of interactions has been complete, the terminal application 339 can close the transaction session.

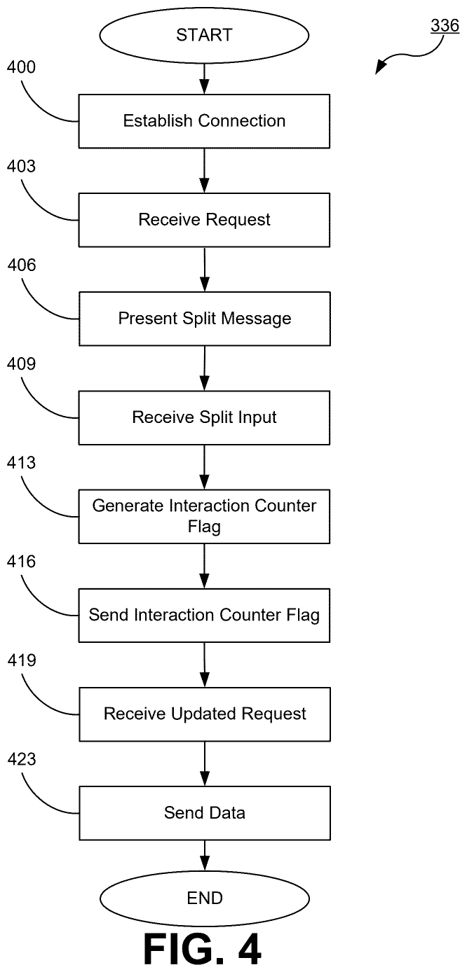

Referring next to FIG. 4, shown is a flowchart that provides one example of the operation of a portion of the interaction application 336. The flowchart of FIG. 4 provides merely an example of the many different types of functional arrangements that can be employed to implement the operation of the depicted portion of the interaction application 336. As an alternative, the flowchart of FIG. 4 can be viewed as depicting an example of elements of a method implemented within the network environment 300.

Beginning with block 400, the interaction application 336 can be executed to establish a connection. The interaction application 336 can establish a secure short-range connection with a terminal application 339 of a transaction terminal 103. In some examples, the interaction application 336 and the terminal application 339 can establish a secure short-range wireless connection using near-field communication (NFC) technology supported on the client device 100 and the transaction terminal 103. In other examples, the interaction application 336 and the terminal application 339 can establish a secure short-range wireless connection with BLUETOOTH®, Wi-Fi, ultra-wideband (UWB), etc. In some examples, establishing the connection comprises sending and/or receiving signals and verifying that the connection is permissible to both the interaction application 336 and the terminal application 339.

Next, at block 403, the interaction application 336 can be executed to receive one or more requests 323. The interaction application 336 can receive the requests 323 from a terminal application 339 or other application in the network environment 300. In some examples, the interaction application 336 receives the requests 323 over a secure short-range connection which has been established. The interaction application 336 can receive the requests 323 in response to the connection being established.

At block 406, the interaction application 336 can be executed to present a split message in a user interface. A split message can be representative of a message or notice which can be sent to a user interface 106 on a client device 100 to prompt a user to designate a number of splits. Similar to the user interface 106 shown in FIG. 1, the split message can request a user to specify a number of interactions to be completed for a transaction. In some examples, the split message can instead comprise a message giving the user an option to specify an amount to contribute to the transaction.

At block 409, the interaction application 336 can be executed to receive a split input. A split input can comprise an input, message, response, or notification indicating a total number of interactions which will be involved in a transaction. In some examples, the split input can comprise a partial contribution toward a total transaction amount. The split input can originate from a user's interactions with a user interface element 109 on a user interface 106. In some examples, the interaction application 336 can receive the split input from the user interface 106. However, in some examples, the interaction application 336 can receive the split input from another system, service, or application in the network environment 300.

Next, at block 413, the interaction application 336 can be executed to generate an interaction counter flag 316. The interaction application 336 can generate the interaction counter flag 316 based at least in part on the split input received at block 409. The interaction application 336 can determine the number of total interactions specified by the input and generate an interaction counter flag 316 corresponding to the total number of interactions specified. In some examples, the interaction application 336 can generate the interaction counter flag 316 based at least in part on the requests 323 received at block 403. For example, the interaction counter flag 316 can be based at least in part on a number of requests 323 received.

Moving to block 416, the interaction application 336 can be executed to send the interaction counter flag 316. The interaction application 336 can utilize the secure short-range connection established at block 400 to send the interaction counter flag 316 generated at block 413. In some examples, the interaction application 336 can send the interaction counter flag 316 to the terminal application 339 in response to receipt of the requests 323 at block 403. In some examples, the interaction application 336 can send the interaction counter flag 316 to the terminal application 339 along with interaction data 319.

At block 419, the interaction application 336 can be executed to receive an updated request 323. In some examples, before the interaction application 336 has sent interaction data 319, the interaction application 336 can send the interaction counter flag 316 to the terminal application 339 and receive an updated request 323 in return. For example, if the initial request 323 received at block 403 was for a total transaction amount, the terminal application 339 can receive the interaction counter flag 316 or a split input from block 409 and update the request 323 from block 403 to comprise a partial request 323.

Next, at block 423, the interaction application 336 can be executed to send interaction data 319. If the interaction application 336 has not already sent interaction data 319 along with the interaction counter flag 316 at block 416, the interaction application 336 can send interaction data 319 after receiving an updated request from the terminal application 339 at block 419. In some examples, the interaction application 336 can send interaction data 319 to the terminal application 339 based at least in part on the request(s) received at block 403. The interaction application 336 can send interaction data 319 to another system, service, or application in the network environment 300. After block 423, the flowchart of FIG. 4 can end.

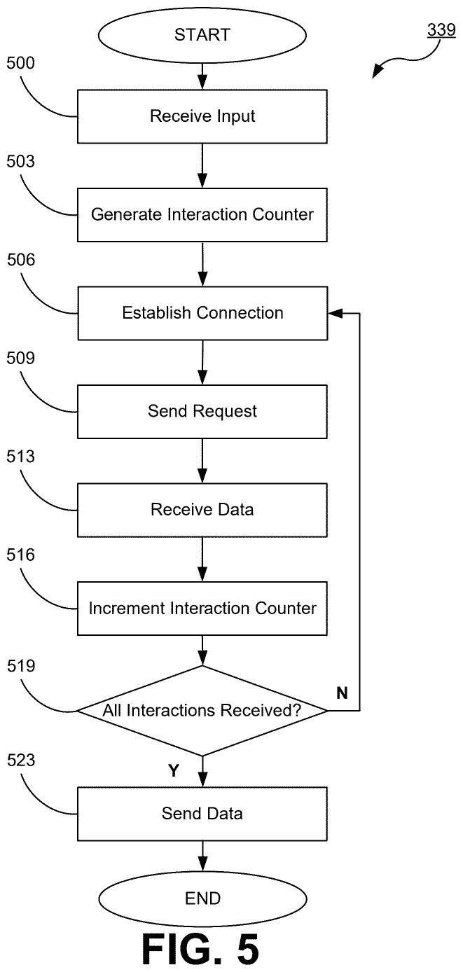

Referring next to FIG. 5, shown is a flowchart that provides one example of the operation of a portion of the terminal application 339. The flowchart of FIG. 5 provides merely an example of the many different types of functional arrangements that can be employed to implement the operation of the depicted portion of the terminal application 339. As an alternative, the flowchart of FIG. 5 can be viewed as depicting an example of elements of a method implemented within the network environment 300.

Beginning with block 500, the terminal application 339 can be executed to receive one or more inputs. The inputs can be representative of data, messages, signals, or notifications received by the terminal application 339 indicating that a transaction will have multiple interactions. In some examples, the inputs are received by the terminal application 339 from a user interface 106 on the transaction terminal 103. The terminal application 339 can receive the inputs in response to generating a split message for the user interface 106.

Next, at block 503, the terminal application 339 can be executed to generate an interaction counter 317. In some examples, the terminal application 339 can generate an interaction counter flag 316 to be shared with a client device 100. In some examples, the terminal application 339 generates an interaction counter 317 to count interactions which are part of the same transaction session. The terminal application 339 can generate the interaction counter 317 based at least in part on the input received at block 500. For example, the terminal application 339 can generate an interaction counter 317 which counts the total number of interactions involved in a transaction which was specified in the input from block 500.

At block 506, the terminal application 339 can be executed to establish a connection. Similar to the process described in block 400 of FIG. 4, the terminal application 339 can establish a secure short-range connection with an interaction application 336 of a client device 100. In some examples, the terminal application 339 and the interaction application 336 can establish a secure short-range wireless connection using near-field communication (NFC) technology supported on the client device 100 and the transaction terminal 103. In other examples, the interaction application 336 and the terminal application 339 can establish a secure short-range wireless connection with BLUETOOTH®, Wi-Fi, ultra-wideband (UWB), etc. In some examples, establishing the connection comprises sending and/or receiving signals and verifying that the connection is permissible to both the terminal application 339 and the interaction application 336.

Moving to block 509, the terminal application 339 can be executed to send one or more requests 323. The terminal application 339 can send the requests 323 to an interaction application 336 on a client device 100 or other application in the network environment 300. In some examples, the terminal application 339 sends the requests 323 over a secure short-range connection which has been established at block 506. The terminal application 339 can send the requests 323 in response to the connection being established. In some examples, the terminal application 339 generates the requests 323 based at least in part on the input received at block 500 and sends the requests 323 to the interaction application 336 to which a connection has been established.

At block 513, the terminal application 339 can be executed to receive interaction data 319. The terminal application 339 can receive interaction data 319 from an interaction application 336 after sending a request 323 at block 509. In some examples, the terminal application 339 can receive interaction data 319 from the interaction application 336 using the connection established at block 506. In some examples, the terminal application 339 can receive the interaction data 319 from another system, service, or application in the network environment 300.

At block 516, the terminal application 339 can be executed to increment the interaction counter 317. Based at least in part on having received interaction data 319, the terminal application can be executed to increment the interaction counter 317 generated at block 503. The terminal application 339 can increment the interaction counter 317 by decreasing or increasing the integer value of the counter according to the number of pieces of interaction data 319 received. For example, if one message of interaction data 319 was received, the terminal application 339 could change a value of the interaction counter 317 from zero to one. In some examples, the interaction counter 317 can be a fraction counter and when incremented could increase by a fraction (e.g., increment from 0/3 to ⅓, from ⅖ to ⅗, from ½ to 2/2, etc.).

At block 519, the terminal application 339 can be executed to determine whether all interactions have been received. Using the interaction counter 317 generated at block 503, the terminal application 339 can determine whether all interactions have occurred. The terminal application 339 can determine whether the interactions have occurred based at least in part on the number of times the interaction counter 317 has been incremented at block 516. In some examples, the terminal application 339 can determine whether the interactions have been received based at least in part on the inputs from block 500, the interaction counter 317 generated at block 503, the interaction data 319 received at block 513, or any combination of these elements. For example, the terminal application 339 can determine whether all interactions have been received based at least in part on whether a total balance of a transaction has been satisfied. Using the interaction data 319, the terminal application 339 can determine a total amount of received payments and compare that to a total amount of the transaction. If the total amount of the transaction has been accounted for in the interaction data 319 received at block 513, the terminal application 339 can conclude that the interactions have been received and proceed to block 523. If the terminal application 339 instead concludes that further interaction data 319 is needed to account for an outstanding balance, the terminal application 339 can repeat blocks 506 or 509 through 516.

If the terminal application 339 determines that not all interactions have been received, the terminal application 339 can repeat the process of blocks 506 through 519 until the interactions have occurred. In some examples, the terminal application 339 only repeats blocks 509 through 519 until the interactions have occurred. In some examples, the terminal application 339 optionally repeats block 506 based at least in part on whether a new client device 100 is needed to perform the next interaction. If the terminal application 339 determines that all interactions have been received, the terminal application 339 can proceed to block 523.

At block 523, the terminal application 339 can be executed to send interaction data 319. Once the terminal application 339 has received all necessary interaction data 319 from block 513, the terminal application 339 can forward interaction data 319 to respective verifier applications 309. In some examples, the terminal application 339 can determine an appropriate verifier application 309 based at least in part on the interaction data 319 and send the interaction data 319 to that verifier application 309. For example, the terminal application 339 can determine a financial institution associated with a payment method in the interaction data 319 and forward the interaction data to the financial institution's verifier application 309. In some examples, the terminal application 339 can send the interaction data 319 to another system, service, or application in the network environment 300. After block 523, the flowchart of FIG. 5 can end.

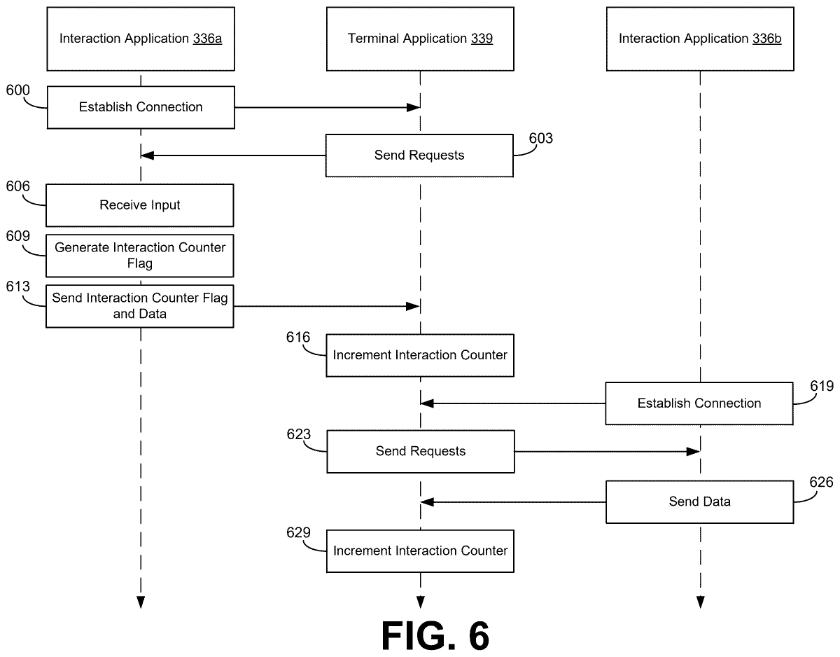

Referring next to FIG. 6, shown is a sequence diagram that provides one example of the operation of the interactions between a first interaction application 336a, the terminal application 339, and a second interaction application 336b. The sequence diagram of FIG. 6 provides merely an example of the many different types of functional arrangements that can be employed to implement the operations of the depicted portions of the first interaction application 336a, the terminal application 339, and the second interaction application 336b. As an alternative, the sequence diagram of FIG. 6 can be viewed as depicting an example of elements of a method implemented within the network environment 300.

Beginning with block 600, a first interaction application 336a can establish a connection. As described at block 400 of FIG. 4, the first interaction application 336a can establish a secure short-range connection with a terminal application 339 of a transaction terminal 103. In some examples, the first interaction application 336a and the terminal application 339 can establish a secure short-range wireless connection using near-field communication (NFC) technology supported on the client device 100 and the transaction terminal 103. In other examples, the first interaction application 336a and the terminal application 339 can establish a secure short-range wireless connection with BLUETOOTH®, Wi-Fi, ultra-wideband (UWB), etc. In some examples, establishing the connection comprises sending and/or receiving signals and verifying that the connection is permissible to both the first interaction application 336a and the terminal application 339.

Next, at block 603, the terminal application 339 can be executed to send one or more requests 323. As described in block 509 of FIG. 5, the terminal application 339 can send the requests 323 to the first interaction application 336a on a first client device 100a. In some examples, the terminal application 339 sends the requests 323 over a secure short-range connection which has been established at block 600. The terminal application 339 can send the requests 323 in response to the connection being established.

At block 606, the first interaction application 336a can be executed to receive one or more inputs. As described at block 409 of FIG. 4, the first interaction application 336a can receive a split input. In some examples, the first interaction application 336a can receive the split input from the user interface 106 of the first client device 100a.

Moving to block 609, the first interaction application 336a can be executed to generate an interaction counter flag 316. As described at block 413 of FIG. 4, the first interaction application 336a can generate the interaction counter flag 316 based at least in part on the input received at block 606. The first interaction application 336a can determine the number of total interactions specified by the input and generate an interaction counter flag 316 corresponding to the total number of interactions specified. In some examples, the first interaction application 336a can generate the interaction counter flag 316 based at least in part on the requests 323 received at block 603. For example, the interaction counter flag 316 can be based at least in part on a number of requests 323 received.

Next, at block 613, the first interaction application 336a can be executed to send the interaction counter flag 316 and interaction data 319 to the terminal application 339. The first interaction application 336a can utilize the secure short-range connection established at block 600 to send the interaction counter flag 316 generated at block 609 and interaction data 319 corresponding to the request from block 603. However, in some examples, the first interaction application 336a can send the interaction counter flag 316 using the connection established at block 600 and establish a second connection to send the interaction data 319. For example, a first NFC tap can be utilized to share the interaction counter flag 316 and a second NFC tap can be utilized to share the interaction data 319. Alternatively, both the interaction counter flag 316 and the interaction data 319 can be shared in one NFC tap. In some examples, the first interaction application 336a can send the interaction counter flag 316 to the terminal application 339 in response to receipt of the requests 323 at block 603.

At block 616, the terminal application 339 can be executed to increment an interaction counter. The terminal application 339 can receive the interaction counter flag 316 form the first interaction application 336a at block 613 and set up an interaction counter 317 to count to a total number of interactions. The terminal application 339 can increment the interaction counter 317 based at least in part on receiving interaction data 319 from the first interaction application 336a at block 613. Further details about how the terminal application 339 can increment the interaction counter 317 can be found in the discussion of block 516 of FIG. 5.

Moving to block 619, a second interaction application 336b can be executed to establish a connection. In some examples, the second interaction application 336b is hosted on the first client device 100a. However, in some examples, the second interaction application 336b is hosted on a second client device 100b. Much like the first interaction application 336a, the second interaction application 336b can follow the steps described in block 600 to establish a secure short-range wireless connection with the terminal application 339.

Next, at block 623, the terminal application 339 can be executed to send one or more requests 323. The terminal application 339 can send the one or more requests 323 to the second interaction application 336b as described in the discussion of block 603 for the first interaction application 336a. The terminal application 339 can send different requests 323 to the second interaction application 336b than it sent to the first interaction application 336a.

At block 626, the second interaction application 336b can be executed to send interaction data 319. In some examples, the second interaction application 336b can send interaction data 319 to the terminal application 339 in a similar manner as described in the discussion of block 613. However, the second interaction application 336b can send interaction data 319 corresponding to the second request 323 of block 623 instead of the first request 323 of block 603.

At block 629, the terminal application 339 can be executed to increment the interaction counter 317. The terminal application 339 can increment the interaction counter 317 based at least in part on receiving interaction data 319 from the second interaction application 336b at block 626. The incrementing at block 629 can be in addition to the incrementing at block 616. The terminal application 339 can repeat the process described with the second interaction application 336b with any number of additional interaction applications 336 until the interaction counter 317 has reached the total number of interactions. After block 629, the sequence diagram of FIG. 6 can end.

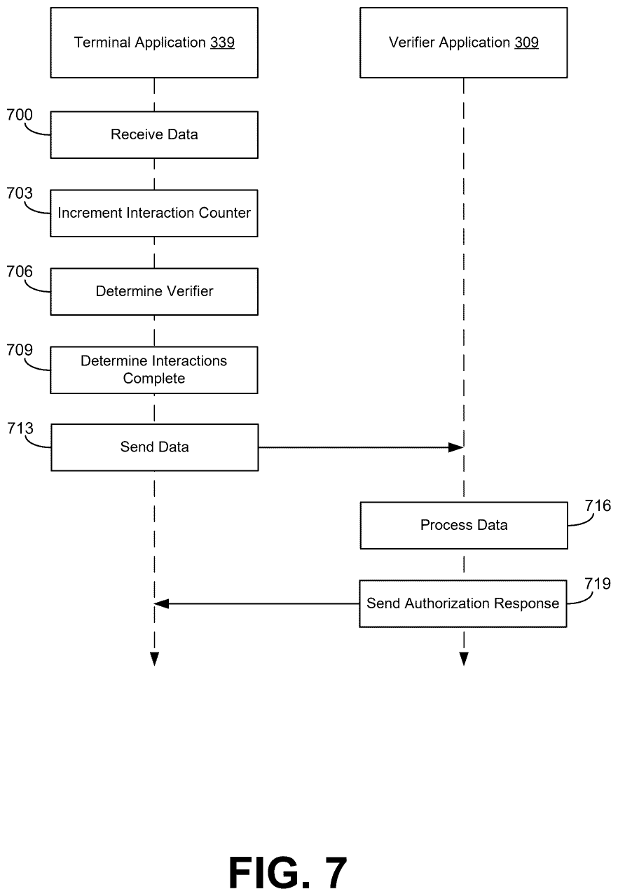

Referring next to FIG. 7, shown is a sequence diagram that provides one example of the operation of the interactions between the terminal application 339 and a verifier application 309. The sequence diagram of FIG. 7 provides merely an example of the many different types of functional arrangements that can be employed to implement the operations of the depicted portions of the terminal application 339 and the verifier application 309. As an alternative, the sequence diagram of FIG. 7 can be viewed as depicting an example of elements of a method implemented within the network environment 300.

Beginning with block 700, the terminal application 339 can be executed to receive interaction data 319. As described previously, the terminal application 339 can receive interaction data 319 from an interaction application 336 after sending a request 323. In some examples, the terminal application 339 can receive interaction data 319 from the interaction application 336 using a previously-established connection.

At block 703, the terminal application 339 can be executed to increment the interaction counter 317. Based at least in part on having received interaction data 319 at block 700, the terminal application 339 can be executed to increment the interaction counter 317. The terminal application 339 can increment the interaction counter 317 by decreasing or increasing the integer value of the counter according to the number of pieces of interaction data 319 received.

Next, at block 706, the terminal application 339 can be executed to determine a verifier. The verifier can be an entity responsible for verifying interaction data 319. For example, the verifier can be a financial institution responsible for verifying financial information in the interaction data 319. In another example, the verifier can be an identity verifier responsible for verifying identification information within the interaction data 319. Thus, the terminal application 339 can determine a verifier corresponding to the interaction data 319 based at least in part on the interaction data 319 received at block 700.

At block 709, the terminal application 339 can be executed to determine that all interactions have been completed. In some examples, the terminal application 339 can determine whether the interactions have occurred based at least in part on the number of times the interaction counter 317 has been incremented at block 703. In some examples, the terminal application 339 can determine whether the interactions have been received based at least in part on the interaction data 319 from block 700, the incremented interaction counter 317, or any combination of these elements. In some examples, the terminal application 339 can be determine whether all interactions have been received based at least in part on whether the interaction data 319 that accounts for a total balance of a transaction indicates that the total amount required has been satisfied. The terminal application 339 can determine a total amount of received payment based at least in part on the interaction data 319 from block 700 and compare the amount received to a total amount of the transaction.

Next, at block 713, the terminal application 339 can be executed to send the interaction data 319. Once the terminal application 339 has received all necessary interaction data 319 from block 700 and incremented the interaction counter 317 to the total number of interactions, the terminal application 339 can forward interaction data 319 to the verifier applications 309.

Next, at block 716, the verifier application 309 can be executed to process the interaction data 319. After receiving the interaction data 319 from the terminal application 339, the verifier application 309 can process the interaction data 319. In some examples, the verifier application 309 can process payment information, verify an identity claim, or other downstream authorization processes to complete the transaction.

Next, at block 719, the verifier application 309 can be executed to send an authorization response. The authorization response can be message, notification, signal, or other transmission which communicates to the terminal application 339 that the interaction data 319 has been verified and/or authorized. In some examples, the verifier application 309 can send the authorization response in response to having processed the interaction data 319 successfully at block 716. In some examples, the verifier application 309 can send the authorization response to an interaction application 336 as well.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 303.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive an input from a user interface, the input indicating a number of interactions associated with a transaction session;
generate an interaction counter for the transaction session based at least in part on the number of interactions;
send a request for a first set of data corresponding to a first interaction of the number of interactions;
receive the first set of data in response to the request; and
increment the interaction counter based at least in part on the first set of data for the first interaction.

2. The system of claim 1, wherein the machine-readable instructions, when executed by the processor, further cause the computing device to at least generate the request for the first set of data based at least in part on the number of interactions.

3. The system of claim 1, wherein the machine-readable instructions, when executed by the processor, further cause the computing device to at least establish a secure short-range connection with a client device.

4. The system of claim 3, wherein the machine-readable instructions further cause the computing device to at least:
establish a second secure short-range connection with a second client device;
send a request for a second set of data corresponding to a second interaction of the number of interactions;
receive the second set of data in response to the request; and
increment the interaction counter based at least in part on the second set of data for the second interaction.

5. The system of claim 1, wherein the machine-readable instructions, when executed by the processor, further cause the computing device to at least determine a verifier for the first set of data based at least in part on the request for the first set of data and the first set of data.

6. The system of claim 5, wherein the machine-readable instructions, when executed by the processor, further cause the computing device to at least:
determine the number of interactions has been received based at least in part on the interaction counter; and
send at least the first set of data to the verifier.

7. The system of claim 1, wherein the machine-readable instructions, when executed by the processor, further cause the computing device to at least:
generate a split message, the split message comprising an option to split the request for the first set of data into two or more interactions; and
present the split message in a user interface, wherein the input is received in response to the split message.

8. A method, comprising:
receiving, by a computing device, an input from a user interface, the input indicating a number of interactions associated with a transaction session;
generating, by the computing device, an interaction counter for the transaction session based at least in part on the number of interactions;
sending, by the computing device, a request for a first set of data corresponding to a first interaction of the number of interactions;
receiving, by the computing device, the first set of data in response to the request; and
incrementing, by the computing device, the interaction counter based at least in part on the first set of data for the first interaction.

9. The method of claim 8, further comprising generating, by the computing device, the request for the first set of data based at least in part on the number of interactions.

10. The method of claim 8, further comprising establishing, by the computing device, a secure short-range connection with a client device.

11. The method of claim 10, further comprising:
establishing, by the computing device, a second secure short-range connection with a second client device;
sending, by the computing device, a request for a second set of data corresponding to a second interaction of the number of interactions;
receiving, by the computing device, the second set of data in response to the request; and
incrementing, by the computing device, the interaction counter based at least in part on the second set of data for the second interaction.

12. The method of claim 8, further comprising determining, by the computing device, a verifier for the first set of data based at least in part on the request for the first set of data and the first set of data.

13. The method of claim 12, further comprising:
determining, by the computing device, the number of interactions has been received based at least in part on the interaction counter; and
sending, by the computing device, at least the first set of data to the verifier.

14. The method of claim 8, further comprising:
generating, by the computing device, a split message, the split message comprising an option to split the request for the first set of data into two or more interactions; and
presenting, by a user interface, the split message, wherein the input is received in response to the split message.

15. A system, comprising:
a computing device comprising a processor and a memory; and
machine-readable instructions stored in the memory that, when executed by the processor, cause the computing device to at least:
receive a request for data from a transaction terminal to complete a transaction session;
receive an input indicating a number of interactions associated with the transaction session;
generate an interaction counter flag based at least in part on the number of interactions; and
send the interaction counter flag to the transaction terminal.

16. The system of claim 15, wherein the machine-readable instructions further cause the computing device to at least establish a secure short-range connection with the transaction terminal.

17. The system of claim 15, wherein the machine-readable instructions further cause the computing device to at least:
generate a split message, the split message comprising an option to split the request for data into two or more interactions; and
present the split message in a user interface, wherein the input is received in response to the split message.

18. The system of claim 15, wherein the machine-readable instructions further cause the computing device to at least:
identify data corresponding to the request for data; and
send the data to the transaction terminal with the interaction counter tag.

19. The system of claim 15, wherein the machine-readable instructions further cause the computing device to at least receive an updated request for data from the transaction terminal based at least in part on having sent the interaction counter tag.

20. The system of claim 15, wherein the interaction counter flag instructs the transaction terminal to receive the number of interactions before closing the transaction session.
